(19) United States
(12) Patent Application Publication
(10) Pub. No.: US 2013/0138494 A1
(43) Pub. Date: May 30, 2013

(54) Method for the electronic transmission of receipts to a central database and use of the contents of the receipts thereof

(71) Applicant: Randolph Steven Levine, Houston, TX (US)

(72) Inventor: Randolph Steven Levine, Houston, TX (US)

(21) Appl. No.: 13/694,094

(22) Filed: Oct. 30, 2012

Related U.S. Application Data
(60) Provisional application No. 61/628,512, filed on Nov. 1, 2011.

(51) Int. Cl. G06Q 30/02

(52) U.S. Cl. CPC G06Q 30/0224
USPC 705/14.25

(57) ABSTRACT

A method for the electronic transmission of receipts to a central database and use of the contents thereof. The use of the contents of the receipts by the consumer and at the option of the consumer to receive coupons, discounts, information and other items from manufacturers, retailers or anyone else. The invention relates to commerce, the internet, record keeping, retail purchases, credit card charges, banking, accounts payable and receivables, marketing, purchase incentives, coupons, etc. The receipts may be transmitted at points of sale or by companies or institutions to: a website, an e-mail account, a portable wireless device, a portable device that has a wire for input, a tablet computer, a portable computer, a memory card, stick or other device. The receipt is preserved and a copy is retrievable by the consumer.

### BACKGROUND OF THE INVENTION

Receipts received at retail stores can be unclear, vary in the intensity of the printing, vary in the quality of the paper, can degrade, can fade, can be damaged, can be lost, are not entered into a database or format for any use directly by the consumer, and do frequently have more detail than an entry of the transaction on a bank statement or credit card statement.

### SPECIFICATION AND DETAILS OF THE INVENTION THE FIELD OF THE INVENTION RELATES TO

Commerce, The Internet, Record Keeping, Retail Purchases, Credit Card Charges, Banking, Accounts Payable and Receivables, Marketing, Purchase Incentives, Coupons, etc.

### BRIEF SUMMARY OF THE INVENTION

A method for the electronic transmission of receipts to a central database and use of the contents of the receipts thereof by the consumer and at the option of the consumer to receive coupons, discounts, information and other items from manufacturers, wholesalers, retailers or anyone else.

### DETAILED DESCRIPTION OF THE INVENTION

A method for the electronic transmission of receipts to a central database and use of the contents of the receipts thereof is the invention herein.

The receipts may be transmitted at points of sale or by companies or institutions to: a website, an e-mail account, a portable wireless device, a portable device that has a wire for input, a tablet computer, a portable computer, a memory card, stick or other device.

The receipt is preserved and a copy is retrievable by the consumer.

An account number for the website is established at the retail location, by mail or on a computer, by a credit card company, by a bank etc.

The password is unique and assigned by the institution or picked by the consumer or customer.

The receipt is retrieved on a website by accessing an account and entering a password.

The account contains only the receipts for a particular consumer or customer.

The other devices mentioned are under the control of the consumer and have standard methods of retrieving information.

The receipt and it's contents are available for the use of the consumer or customer whose transaction caused the receipt to be generated.

There are applications available on the website that are free or can be purchased.

Some applications are: the language of use on the site, bookkeeping, accounting, analysis of purchases, expense accounting, income tax preparation, state income tax preparation, property tax analysis, utilities analysis.

Also will be available an opt in or opt out participation, where the particular information not to be released is designated, in interactive applications with manufacturers, wholesalers, retailers or others wishing to provide coupons, discounts, rebates, rewards, credits based on the information in the receipts.

They could do this in one website reaching large numbers of customers and consumers.

This would be a very efficient and effective means to do this rather than on an individual basis.

The marketing information would be very valuable to the above suppliers and could increase sales. The consumer and customer could benefit by a centralized and organized source of coupons and other savings with or without paper coupons etc.

The site could be interactive with the point of sale to automatically deduct all coupons, discounts, credits etc at the time of purchase which have been loaded into the account.

Another feature would be interactive where the consumer could ask for coupons etc for a particular item, company or retailer etc. without having to look through newspapers, the internet or other sources of coupons, discounts, etc.

A source of revenue for the website could be fees paid by any of the entities mentioned, by the consumer or others for access to the website.

Another source of fees for the website could be retailers who would save on paper and ink and provide a potential source of savings for their customers.

An additional source of revenue for the website could be advertising.

Another feature of the site would be access to associated notices, ads, instructions for products, warnings, recalls, manuals, warranties etc.

The website can also accommodate non-retail product receipts, for example services.

Another feature beyond the point of sale receipts would be payments of bills by computer interactive with bank accounts, credit cards etc thus including receipts for the consumer's financial database in general.

Another feature would be where retailers enter their specials into the website and a consumer or customer can optimize their savings for purchases with or without entering parameters such as number of stores to shop, a geographic area etc.

1. A method for the electronic transmission of receipts, detailed or otherwise, to a central database, on the internet or elsewhere, and use of the contents thereof by the consumer and at the option of the consumer to receive coupons, discounts, information and other items from manufacturers, wholesalers, retailers or anyone else.

2. The method of claim 1 wherein claim 1 includes the receipts may be transmitted at points of sale or by companies or institutions to: a website, an e-mail account, a portable wireless device, a portable device that has a wire for input, a tablet computer, a portable computer, a memory card, stick or other device, wherein the receipts are retrievable by the consumer by means of an account number and/or account name and/or password.

3. The method of claim 1 wherein there are: options of applications available on the website that are free or can be purchased, options designated to participate or not participate wherein particular information in the receipts is available in interactive applications with manufacturers, wholesalers, retailers or others wishing to provide coupons, discounts, rebates, rewards, credits based on the information in the receipts wherein said coupons, discounts, credits etc can be sent or received at the point of sale and deducted or credited at the at the time of purchase or they can be downloaded by the consumer to be used at a selected time by the consumer, and the options would be interactive where the consumer could ask for coupons etc for a particular item, company or retailer, with or without options selected proximity or locations of stores and the consumer would also have access to other items besides monetary items such as notices, ads instructions for products, warnings, recalls, manuals, warranties, etc.

4. The method of claim 1 wherein a source of revenue for the website could be fees paid by any of the entities, consumers or others for access to the website.

5. The method of claim 1 wherein a feature beyond the point of sales receipts would be payments of bills by computer interactive with different forms of payment such as bank accounts, credit cards etc thus including receipts for the consumer's financial database in general.
